(19) United States
(12) Patent Application Publication
(10) Pub. No.: US 2004/0143063 A1
(43) Pub. Date: Jul. 22, 2004

(54) Nano-scale bicontinuous network structure of block copolymer with immiscible polymer chain segments and application thereof

(76) Inventors: Teng-Ko Chen, Jung-Li City (TW); Shin-Min Huang, Jung-Li City (TW)

Correspondence Address: BIRCH STEWART KOLASCH & BIRCH, PO BOX 747, FALLS CHURCH, VA, 22040-0747, US

(21) Appl. No.: 10/755,320

(22) Filed: Jan. 13, 2004

(30) Foreign Application Priority Data
Jan. 17, 2003 (TW) 092101026

(51) Int. Cl. C08G 18/00

(52) U.S. Cl. 525/131

(57) ABSTRACT

The present invention relates to a phase separated bicontinuous polymeric network structure of block copolymer with two phases interpenetrating each other. The width of each phase is 0.3 to 5 nm, respectively. The polymer chain segments in one of the continuous network phase are aligned in an extended ordered array. The other polymer chain segment of the same block copolymer is in an amorphous physical state, which constitutes the other continuous network phase. Polymeric materials made of this nano-scale bicontinuous network is a novel material exhibiting desired properties such as high clarity, high tensile strength and modulus, high toughness, good solvent cast processibility and retention of adequate mechanical properties up to a temperature much higher than Tg and/or Tm of each polymer chain segment. The nano-scale bicontinuous network structure can be further developed for the applications of conducting polymers, membrane polymers, adsorption polymers, and biomedical polymers to extend the application values.

### BACKGROUND OF THE INVENTION

1. Field of the Invention

The present invention relates to a nano-scale phase separated bicontinuous network structure of block copolymer with immiscible polymer segments. One of the continuous network phase is formed by aligning the extended polymer segments in an ordered array, and the other continuous network phase is formed by the other polymer segments in an amorphous physical state. Polymeric material with the nanostructure exhibits high transparency, high tensile stress and modulus, high toughness, good solvent cast processibility and great retention of these properties to a much higher temperature.

2. The Prior Arts

The family of waterborne polyurethane is a well-known multiblock copolymer owing to the excellent mechanical properties and versatile applications. Prior studies on waterborne segmented polyurethane are the most related in areas of synthesis and structure-property relationship of present invention. Fundamental aspects of this polyurethane including the synthetic methods, film properties, and stabilities of aqueous dispersion have been well studied. However, the relationship between self-assembly phase changes of soft and hard segments and physical properties of this nano-material remained to be elucidated.

Soft segments of commercial waterborne polyurethanes are all based on polar polyols, such as polyether-polyols and polyester-polyols. The phase-separated nanostructure thereof is not observable under electron microscope. However, structure analysis is carried out partially with differential scanning calorimeter (DSC), dynamic mechanical analyzer (DMA), small angle X-ray scattering (SAXS) and wide-angle X-ray diffraction (WAXD). Vague assumptions on the real nanostructure of the two-phase polyurethane were made with the abovementioned apparatuses. Without resolving the real nanostructure of the two-phase polymer, there is no clear explanation for mechanical properties thereof. Furthermore, the studies and applications of waterborne polyurethane having commercial application values only focus on the use of polyurethane with low hard segment content. The structure and property of waterborne polyurethane with high hard segment content attracts less attention. Therefore, the application of the waterborne polyurethane is limited to certain areas but not developed prosperously in various fields.

### SUMMARY OF THE INVENTION

A primary object of the present invention is to provide a nano-scale phase separated bicontinuous network structure of immiscible polymer segments of a block copolymer, which structure provides desired properties such as high transparence, high tensile stress and modulus, high toughness, good solvent cast processibility and great retention of these properties to a much higher temperature.

Another object of the present invention is to provide a nanoporous material made of the abovementioned block copolymer with pore size of 0.3-5 nm.

Block copolymer is a material which has been known and widely used, wherein the family of segmented waterborne polyurethanes are one of the major block copolymers widely applied in coating and adhesive industries. Although fundamental aspects of these polyurethanes, including the synthetic methods, film properties, and stabilities of the aqueous dispersion, have been well studied, there is no advanced study toward the relationship between self-assembly phase changes of soft and hard segments and physical properties of this family of polymeric material.

The inventors have devoted to the present invention under the nano-scale level, to the study of the relationship between self-assembly phase changes of soft and hard segments and to understand of physical properties of this waterborne polyurethane material. The inventors studied the phase separated nanostructure changes due to polyurethane chain segments of various chain segment weights and of various monomer components, and/or of various ionic groups and contents. Several waterborne polyurethanes with different polybutadiene soft segments at various molecular weights and with different hard segment compositions and different ionic group content were synthesized. Then the morphological structures of these poyurethanes were analyzed with the instruments such as thermogravimetry analyzer, differential scanning calorimeter, transmission electron microscope and dynamic mechanical analyzer. The phase changes from the self-assembly of soft or hard segments and the conformational arrangements of polymer chain segments thereof were studied in the nanometer range. A nano-scale phase separated bicontinuous interpenetrating network structure was therefore found.

According to the present invention, the phase separated nanostructure of our waterborne polyurethanes is a bicontinuous polymeric networks with two phases interpenetrating each other. The width of each phase is 0.3 to 5 nm, respectively. The polymer chain segments in one of the continuous network phases are aligned in an extended ordered array. The other polymer chain segment of the same block copolymer is in an amorphous physical state, which constitutes the other continuous network phase. Polymeric materials made of this nano-scale bicontinuous network structure are a novel material having desired properties such as high clarity, high tensile strength and modulus, high toughness, good solvent cast processibility and retention of adequate mechanical properties up to a temperature much higher than Tg and/or Tm of both polymer chain segments. At room temperature, the block copolymers show a high stretching modulus of conventional glassy polymers, together with a foldable flexibility. Traditionally, such material can be used as substrates to provide valuable properties of high dimensional stability, high tensile modulus, high toughness, high clarity, good solvent casting property, and good retention of physical properties to high temperature.

According to general understanding, the highest temperature for a polymer to retain adequate mechanical strength is decided by the glass transition temperature of an amorphous polymer or melting temperature of a crystalline polymer. Materials which retain adequate mechanical strength to a high temperature is referred to as having good high-temperature property. The high-temperature property of the multiblock waterborne polyurethanes made of the bicontinuous interpenetrating network structure according to the present invention thereof was found more than 100° C. higher than that of the related polymers having the same chemical composition and molecular weight of the chain segments in the polyurethanes. Therefore, this phase separated bicontinuous nanostructure help retention of good physical properties to a much higher temperature.

Nanostructure materials made of bicontinuous network structures according to the present invention not only have about the same tensile modulus as that of general glassy polymers, but also show a good flexibility when the testing temperature is higher than glass transition temperature of the amorphous polymer chain segment. On the other hand, when the testing temperature is lower than the glass transition temperature of the amorphous polymer chain segment, such materials will not only have tensile modulus much higher than that of conventional amorphous glassy polymers, but also retain a required toughness for DMA test.

The block copolymer will form a nanoporous material with nano pore size ranging from 0.3 nm to 5 nm if the amorphous continuous polymer network phase is decomposed chemically. In addition, both the polymer chain segments in the bicontinuous nanostructure described in the present invention can be substituted with polymer chain segments of different chemical structures and properties. Nanoporous material with various chemical components can be made according to the present invention by way of the fabricating disclosure. Thus the novel polymeric nanomaterials can be further developed in various areas of membrane polymers, adsorption polymers, biomedical polymers and the like.

The nanostructure of phase separated polymer according to the present invention can be further modified to improve the properties required for further application thereof by way of changing the casting solvents or annealing the resulting film.

The present invention is further explained in the following embodiment illustration and examples. The present invention disclosed above is not limited by these examples. The present invention may be altered or modified a bit and all such variations are within the scope and spirit of the present invention.

### BRIEF DESCRIPTION OF THE DRAWINGS

The related drawings in connection with the detailed description of the present invention to be made later are described briefly as follows, in which:

FIG. 1 shows the image of phase separated bicontinuous nanostructure observed with a Transmission Electron Microscope, as described in the present invention.

FIG. 2 shows the data of phase separated bicontinuous nanostructure prepared according to Example 1: (A) structure image observed with a Transmission Electron Microscope, and (B) the data obtained from a Dynamic Mechanical Analyzer.

FIG. 3 shows the data of phase separated bicontinuous nanostructure prepared according to Example 2: (A) structure image observed with a Transmission Electron Microscope, and (B) the data obtained from a Dynamic Mechanical Analyzer.

FIG. 4 shows the data of phase separated bicontinuous nanostructure prepared according to Example 3: (A) structure image observed with a Transmission Electron Microscope, and (B) the data obtained from a Dynamic Mechanical Analyzer.

FIG. 5 shows the data of phase separated bicontinuous nanostructure prepared according to Example 4: (A) structure image observed with a Transmission Electron Microscope, and (B) the data obtained from a Dynamic Mechanical Analyzer.

FIG. 6 shows the data of phase separated bicontinuous nanostructure prepared according to Example 5: (A) structure image observed with a Transmission Electron Microscope, and (B) the data obtained from a Dynamic Mechanical Analyzer.

FIG. 7 shows the data of phase separated bicontinuous nanostructure prepared according to Example 6 obtained from a Dynamic Mechanical Analyzer.

FIG. 8 shows the data of phase separated bicontinuous nanostructure prepared according to Example 7: (A) structure image observed with a Transmission Electron Microscope, and (B) the data obtained from a Dynamic Mechanical Analyzer.

FIG. 9 shows the data of phase separated bicontinuous nanostructure prepared according to Example 8: (A) structure image observed with a Transmission Electron Microscope, and (B) the data obtained from a Dynamic Mechanical Analyzer.

### DETAILED DESCRIPTION OF THE PREFERRED EMBODIMENT

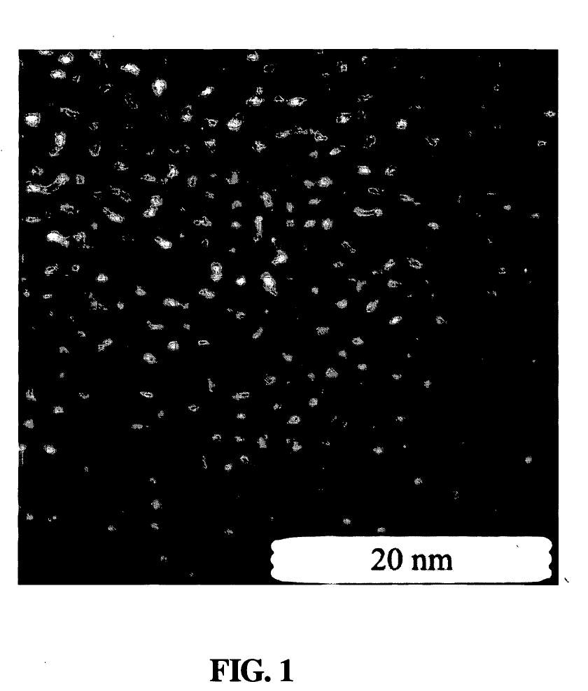

The representative TEM image of bicontinuous network structure of phase separated block copolymer according to the present invention is shown in FIG. 1. The white continuous network phase in the TEM image is constructed from continuously aligning of the extended polymer chain segment of the block copolymer; the black continuous network phase in the TEM image is constructed from the amorphous polymer chain segment of the same block copolymer; the white bulky ball-like portion is the location of a bulky ionic group or a bulky neutral group of the extended polymer chain segment. Such bulky group will provide a branching site to facilitate branching the extended polymer chain segment bundle of the white continuous network phase, and further enables the formation of a phase separated bicontinuous interpenetrating network structure with the coexistence of the amorphous polymer chain segment in the same block copolymer. Wherein the amorphous polymer chain segment fill the interstice of the white continuous network phase. Width of both continuous network phases is 0.3 to 5 nm, preferably from 0.4 to 3.0 nm. The extended polymer chain segment bundle in the image is composed of 2 to 60, preferably 2 to 20, and most preferably 3 to 8 extended polymer chain segments orderly arrayed for constituting the width of the bundle. Such extended polymer chain segments are facilitated to branch into bundles because they contain a monomer unit with an ionic bulky group, or with a neutral bulky group, or itself is a 3-D tortuous monomer unit. An adjacent extended polymer chain segment can align itself to the extended polymer chain segment bundle either before or after branching. A continuous network phase structure is thus constituted by such repeatedly aligning and branching of the extended polymer chain segments.

The basic chemical structures of the above-mentioned copolymers are block copolymers including diblock, triblock, multiblock and comb copolymers. These copolymers can be prepared from step and/or chain polymerization and/or copolymerization.

The polymer structure is represented by the formula:

(˜˜˜˜˜˜˜˜˜˜˜˜˜˜˜++++B+++++B++++++B++)ₙ

wherein “++++B+++++B++++++B++” represents the extended chain segment which is able to align in an ordered array, and therefore to form the polymer chain segment bundle of a continuous network. It can be prepared from step and/or chain polymerization and/or copolymerization. The chain segment molecule weight is from 200 to 20,000, preferably from 300 to 10,000, most preferably from 500 to 7,000. Both ends of the chemical structure of monomer unit “B” need to be capable of copolymerization with “+”. And “B” can provide branching site, which facilitates the formation of the continuous network. The monomer unit “B” is a monomer unit containing bulky pendant group or is a monomer unit with a large bended molecular structure (a tortuous 3-D structure) itself. This large bended structure will also facilitate the formation of branching for the extended polymer chain bundle, therethrough form the continuous phase structure with a three-dimension network. In addition, “B” can also be a comonomer carrying an amorphous polymer chain segment of adequate length. This B monomer unit can, thus, substitute “˜˜˜˜˜”. In this case, the block copolymer is a comb-shape copolymer. However, the “˜˜˜˜˜” block between the extended chain segments can still be reserved. All kinds of above monomer unit “B” can be a neutral entity or an entity carrying ionic functional group. “˜˜˜˜˜˜˜˜˜˜˜˜” represents polymer block which is not compatible with “++++B+++++B++++++B++” polymer block under the preparation temperature and conditions and is an amorphous polymer chain segment constituting the other continuous network phase for the nanomaterial described in the present invention. “n” is 0.5, 1, 1.5, 2, 2.5, 3.5, and so on, with a preferred range of 1.5 to 20. When “n” equals 0.5, there is no “˜˜˜˜˜˜˜˜” but only “++++B+++++B++++++B++” is in the polymer. In such case, “B” is a long chain monomer unit having attached to it an amorphous polymer chain segment to form branches for the resulting comb-shape copolymer and to fill the black portion of FIG. 1.

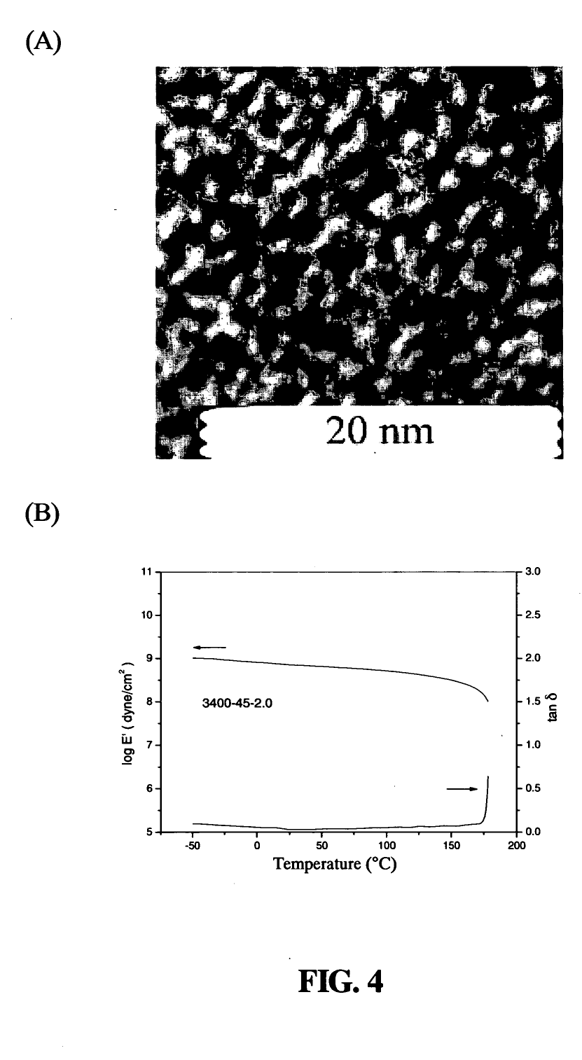

Generally, the weight percentage of hard chain segment is less than 40% in a commercial waterborne PU. However, the formation of the nanostructure in examples of the present invention is highly facilitated when the weight percentage of the extended polymer chain segment (corresponding to the hard segment in the polyurethane Examples) is over 40 wt %. The weight percentage of extended polymer chain segment for various polymeric nanostructure according to the present invention is from 30 to 85%, preferably from 35 to 80%, most preferably from 40 to 75%. When the weight percentage of extended polymer chain segment is low, network of the extended chain segment bundle will be discontinued in some parts of the network structure as shown in FIG. 4. However, FIG. 4 still shows a continuous network shape in an overall view.

The nanostructure constituted of multiblock polymer chain segment mentioned above is a bicontinuous phase structure, and the width of each phase is from 0.3 to 5 nm, preferably from 0.6 to 3.0 nm, most preferably from 0.7 to 2.0 nm. This width is shorter than the wavelength of visible light, therefore the nanostructure prepared according to the present invention is highly transparent. Furthermore, the greater cohesive strength arising from more extensive intermolecular secondary forces among the closely packed extended chain segments greatly enhances tensile modulus, toughness and high-temperature property for the nanomaterial described in the present invention.

The dissolution of some specific compounds with strong intermolecular secondary forces, for examples, dopants of conducting polymers, chromophores of non-linear optical materials and the like, in a bulk polymer generally gives rise to problems of uneven dissolution because of large differences of solubility parameters between the polymer and the specific low-molecular-weight compound. According to the present invention, if these compounds react chemically and become a portion of the B monomer unit, the greater cohesive strength arising from more extensive intermolecular secondary forces among the closely packed extendeded polymer chain segments will exceed the dipole-dipole force or ionic attraction force between the B monomer unit during the formation of the bicontinuous nanostructure. Those not easily dissolvable and highly aggregated chemical entities will thus be promoted to a state of high homogeneous solution, as is similarly shown by the well separated bulky TEM/DMPA ion-pairs in FIG. 1.

A novel nanostructure will provide novel properties for material made of it, and the novel properties will provide some novel applications. The nano-scale phase separated bicontinuous network material mentioned in the present invention can be obtained with special functionalized polymer chain segments. Accordingly, it can dramatically improve their special functions together with the great improvements of the mechanical properties, high-temperature properties and so on.

For example, features which influence the conductivity of a conventional conducting polymer structure are generally summarized as follows:

(a) The main chain of polymer having conjugated double bonds would provide electrical conductivity.

(b) The addition of dopant, which may be electron acceptor or electron donor, will be helpful to rise the conductivity. The higher concentration of dopant yields the better conductivity, and also the better uniform dissolution of dopant yields the better conductivity.

(c) The ordered extended chain arrangement of the polymer enhances inter-chain hopping of the charge. Conducting polymers aligned in an extended array toward the same direction greatly enhances conductivity.

Based on these features of an ideal conducting polymer, the extended polymer chain segment network prepared according to the present invention can fulfill the abovementioned structural features (a) and (c) if the extended polymer chain segment network is composed of monomer units with conjugated double bonds. For the structural feature (b), there are three ways for dopant addition based on the present invention: the first way is to add dopant directly into the amorphous continuous network phase. In this way, dopant can be easily separated between the extended chain segment bunndle of the present invention. In addition, the network of orderly aligned conjugated polymer would remain quite stable owing to the dopant is existing in an adjacent amorphous phase. The second way is to react the dopant functional group onto the amorphous polymer block. This way can be achieved by methods of either copolymerization or polymer reaction. The third way is to make the dopant functional group become the required bulky pendant group on the extended polymer chain segment of the present invention. The later two chemical ways will make the dopant functional group dissolved more uniformly and not migrated out of the bulk polymer. The present invention discloses a phase separated nanostructure which is helpful in aligning extended conjugated polymer as well as uniformly dissolving the dopants. Therefore this invention provides a way to improve the conductivity and life time of conducting polymers.

There are many publications disclosing the improvement of electron conductivity by the interchain hopping in the parallel aligned conducting polymer chains. For example, high conductivity of polyacetylene is believed to be a result from parallel ordered orientation in polymer chain thereof. In addition, the studies of polyaniline conductivity show that the conductivity improved by several orders of magnitude if the polyaniline film is stretched. Accordingly, the optoelectronic properties of polymeric material will be greatly enhanced when monomers of extended conjugated double bonds are used in the preparation of the extended polymer chain segment network as mentioned in the present invention. Furthermore, the enhanced optoelectronic property will also be isotropic due to a three-dimensional isotropic network is resulting from continuous branching of the bundle of the extended polymer chain segments.

Polymeric material of the present invention provides extremely high modulus when it is stretched as well as good flexibility when it is bended. In addition, polymeric material having desired properties such as high clarity and high-temperature properties is also helpful for the application of optoelectronic materials. Thus, material made of polymer nanostructure mentioned in the present invention can be developed in various optoelectronic applications. Based on the above discussion, it is possible to replace conducting glass by a flexible transparent conducting substrate, and to make a flexible and tough touch panel of LCD.

On the other hand, when the pendant group of B monomer unit of the extended polymer chain segment carries a chromophore functional group, such nano material of present invention will provide non-linear optical property for the application of data or image storage if the glass transition temperature of adjacent amorphous polymer phase is high enough to maintain chromophore alignment at the operating temperature of photonic devices. In addition, because these chromophore moieties can be uniformly separated to an adjacent distance of about 1˜2 nm, phase separated nanostructure of the present invention will provide the maximum storage density, before the technology develops to use atom as the element of information storage.

Monomer containing moiety of chromophore or dopant might also be polymerized in between two amorphous polymer chain segments, and then the whole part is regarded as a single amorphous chain segment connecting between the extended polymer chain segment to form the block copolymer for the nanostructure of the present invention.

Besides the continuous network of extended polymer chain segment bundle is used as the conductor as described above, if the amorphous chain segment phase in the present invention is constituted of ion transport polymer (such as poly(ethylene glycol)), the continuous network of the amorphous phase can therefore be used as an ion conducting channel. In addition, because the width of the amorphous phase is extremely small, the passage may be limited to very small ions, such as proton. This function is very important in the development of proton exchange membrane of fuel-cell.

Currently, conducting polymers are still not widely used in commercial application. This is because conducting polymers are limited by the following two aspects: (a) polymers of high conductivity usually exhibit poor processibility and brittle property; (b) polymers with good processibility usually exhibit low conductivity. Nanostructure material prepared according to the present invention can enhance the conductivity, while still providing good solvent cast processibility and tough mechanical property to a greater extent. Theoretically, it can help eliminate the drawbacks in the application of conducting polymer, and extends new application of conducting polymer to many areas.

The possible application of conducting polymer is very broad, generally includes various areas of: battery, light emitting diode, sensor, devices of electronics and opticals, microwave- and conductivity-based technologies, electrochromic devices, electrochemomechanical and chemomechanical devices, corrosion protections, semiconductors, flat printing and electronics, catalysts, and drug/chemical carriers. The nanostructure disclosed in the present invention will not only solve the problems generally encountered in the current application of conducting polymer, but will also create many new conducting polymer applications in the future.

A nanoporous material will be made when a degradable polymer is chosen for the amorphous network phase according to the present invention. In addition, for the preparation of a powdered nanoporous material, polymer particle with bicontinuous network phases is made from emulsified polymerization system and the product is further freeze-dried into powders cis-Polybutadiene chain segment used in the examples of present invention is a good degradable polymer segment which can be easily decomposed by ozone. Because the reaction rate constant of ozone and unsaturated double bond of the cis-polybutadiene is greater than 10⁶/moles/sec, the amorphous cis-polybutadiene phase can be easily removed. Nanoporous film can also be made first by casting very dilute block copolymer solution of the present invention onto a substrate to form an extremely thin film, and then removing the degradable amorphous polymer chain segment. After preparation of these nanoporous materials, width of the continuous network phase with extended chain segment is extremely small. If there is existence of water or solvent, this network phase may be easily destroyed. In order to avoid dissolving in water or solvent, monomer unit of the extended polymer chain segment shall be constituted by some monomer which can perform cross polymerization (Macromolecules, Vol. 23, 1990, page 1017). Cross polymerization forms covalent bonds between extended chain segments. Dissolution of these chain segments and, therefore, the continuous network is virtually impossible.

Nanoporous film prepared with this method has extremely small pore size ranges from 0.3 to 5 nm. When the pores of nanoporous film are smaller than 2 nm, this film can be applied in hyperfiltration techniques for the separation of smaller molecules in a gas-liquid separation. Conventional hyperfiltration involving solution-diffusion of high pressure, slow speed and high cost processes can be replaced with this nanoporous membrane of high-speed convection process. An example of hyperfiltration by using the nanomaterial of present invention is desalination of brackish water. A cross-polymerized extended chain segment in the nanomaterial will be resistant to dissolution by prolong contact with water. An introduced ionic pendant group onto the bulky “B” moiety of the extended chain segment phase can prevent sodium ions and chlorine ions from passing through. Such nanoporous film can further apply to various hyperfiltration applications; used in enzyme separation; used in protein separation or in virus separation; or other usages in membrane technology areas.

Materials used for adsorption are generally made of inorganic material with regular pore size. Although, pore size of the nanoporous particles made according to the present invention is irregular, but polydispersity of pore sizes is not too large. Accordingly, it can be applied in adsorption technology for molecules with large difference in molecular sizes.

Currently, the most important adsorption topic is the adsorption of hydrogen molecule. The size of hydrogen molecule is very small, it can easily enter the crystal lattices of solid alloy (such as palladium, titanium) to form hydrides under proper conditions. However, to release hydrogen back from these hydrides requires a temperature of around 200 to 300 degrees Celsius. In addition, those metals are not only heavy but also costly. These drawbacks cause many inconveniences for the hydrogen adsorption by alloy. Many patents regarding hydrogen adsorption are now focused on the materials including active carbon, graphite, carbon nanofiber and carbon nanotube ever since a Chinese scientist in Singapore has tried to use carbon nanotube to adsorb hydrogen gas. There are two common features from these organic materials described in hydrogen adsorption patents: conjugated double-bonds and pore sizes around 1 nm. Therefore, by using polymer having conjugated double-bond to constitute the continuous network phase of extended polymer chain segments and preparing the nanoporous particles according to the method of the present invention, this nanoporous particle will comprise conjugated double-bond which is similar to the molecular structure of the active carbon, carbon black, graphite and carbon nanotube and the pore sizes will also be about the same as that of these materials. In addition, the 3-D bicontinuous phase structure of these nanoporous particles makes the adsorptive surface larger than the surface area of carbon nanotube in the same unit volume. Thus, the nanoporous particle of the present invention not only provides all the hydrogen adsorption properties of carbon nanotube, but with more advantages. Currently carbon nanotube costs US$150 per gram. It also requires lots of treatment before application. The nanoporous particles made according to the present invention not only cost much less than carbon nanotube, but also can be modified by various extended polymer chain segments. It should be possible to develope a more efficient hydrogen adsorption material for commercial uses. Solving the problems in hydrogen fuel transportation will make a significant progress in the areas of traffic transportation, energy storage of electronic products and environmental protection in the next generation.

In addition, for polymeric materials to be used in the optical application of monitor, there are needs to develop materials with characteristics such as transparency, antiglare, antireflection and antistain. If the surface amorphous network phase of the material made according to the present invention is removed, the nanoporous surface structure of such material will provide those properties mentioned above.

In literatures, the morphology of polymers can be divided into 3 categories: crystalline type, amorphous type, and long range continuously extended form such as that in the liquid crystalline polymer. The morphology of extended polymer chain segments mentioned in the present invention is somewhat similar to that of liquid crystalline polymer in which extended polymer chain segments continuously align in an ordered array. The major difference is that the extended chain segment bundle of present invention branches away in very short distance (<5 nm) and the repeated aligning and repeated branching of the extended polymer chain segments eventually constitute a 3-D continuous network phase. In addition, extended polymer chain segment of the present invention do not need to have a highly stereoregular structure such as that of the crystalline polymers or a rigid rod structure such as that of the liquid crystalline polymers. According to the present invention, many novel material properties will be created if the chemical structure of both the polymer chain segments are changed. Following the synthesis and discovery of new monomers, the applications created from this invented phase-separated bicontinuous nanostructure will be much broader.

### EXAMPLE 1-8

### Preparation of Waterborne Multiblock Polyurethane

A. Sample compositions and molar ratios: as shown in Table 1 and 2.

B. Synthesis Procedures:

1. Hydroxyl terminated polybutadiene, dimethylol propionic acid (DMPA), dibutyltin dilaurate catalyst (0.3 wt % of the total polymer to be synthesized), N-methyl-2-pyrolidinone (NMP) solvent (50 wt % of total polymer to be synthesized) were placed into a four-necked flask fitted with a mechanical stirrer under nitrogen atmosphere. The compositions and molar ratios are showed in Table 1 and 2. The flask was then placed in an oil bath which had been heated to a temperature of 80° C., and the mixture was gently stirred at 100 rpm for 20 minutes.

2. Biscyclohexyl methylene diisocyanate (H₁₂MDI) or hexamethylene diisocyanate (HDI) were added dropwisely into the mixture at 80° C., and then reacted for 4.5 hours.

3. The oil bath temperature was adjusted to 50° C. and then additional N-methyl-2-pyrolidinone solvent (50 wt % of total polymer to be synthesized) was added immediately into the mixture to adjust the viscosity.

4. When the temperature of reaction system reached 50° C., triethylamine (TEA) or tripropylamine (TPA) was added into the mixture to neutralize the carboxylic acid of DMPA monomer unit for 30 minutes.

5. The reaction flask of the above mixture was removed from the 50° C. oil bath to a 20° C. water bath, and the nitrogen was turned off. The stirring rate was switched to 500 rpm and maintained for 3 minutes. The phase inversion was carrying out by adding deionized water (300 wt % of total polymer to be synthesized) dropwisely from an isobaric dropper while vigorously stirring was maintaining in the reaction flask. In the synthesis of HDI polyurethane, the reaction flask of HDI prepolymer was moved from the 50° C. oil bath into a 0° C. ice water bath instead, and then follow the same procedure for phase inversion.

6. After the phase inversion was completed, the chain extension agent ethylene diamine (EDA) was added into the reaction mixture. Then the reaction flask was brought back to a 50° C. oil bath and the stirring speed slowed down to 100 rpm to perform the chain extension process. After 4 hours of reaction time, the aqueous PU dispersion was transferred into a sample bottle.

C. Film Formation

1. Proper amount of aqueous PU dispersion was decanted into a Teflon mould, dried at 40° C. in a air-circulated oven for 3 days, and then removed from the mould.

2. The sample film was further dried at 70° C. under a 10⁻³ torr vacuum oven for 3 days, to obtain a dried sample film with 0.3 mm thickness.

D. Ultramicrotomy and Sample Staining for Transmission Electron Microscopy

1. The waterborne multiblock polyurethane film was first cut by a razer into several long rectangular pieces, and then these pieces were bound to form a sample rod with epoxy glue. The sample rod was further dried at 50° C. and 10⁻³ torr in a vacuum oven for 1 day.

2. The sample rod at −125° C. was cut into ultra-thin sections using a diamond knife fixed on the cutter holder. Ultra-thin sections were then transferred onto a 300 mesh copper grid.

3. The ultra-thin sections were vapor stained with OsO₄ (from a 4 wt % solution) for 24 hours, and were placed in a vacuum oven for 24 hours at room temperature before the transmission electron microscope observation.

### EXAMPLE 9-10

### Preparation of Polyurethane Hard Segment Polymer

A. Sample compositions and molar ratios: as shown in Table 3.

B. Synthesis Procedures:

1. H₁₂MDI and NMP solvent (50 wt % of total polymer to be synthesized) were placed into a 250 ml erlenmeyer flask fitted with a magnetic stirrer under nitrogen atmosphere. The flask was then sealed and placed in an oil bath which had been heated to a temperature of 70-80° C. Then, proper amounts of DMPA, dibutyltin dilaurate (0.6 wt % to total polymer to be synthesized), and NMP (300 wt % of total polymer to be synthesized) were added into another 125 ml erlenmeyer flask and sealed with sleeve stopper. The compositions and molar ratios are also showed in Table 3. After completely dissolved, the mixture in the 125 ml flask was poured into an isobaric dropper and then dropwisely added into the 250 ml erlenmeyer flask. The mixture was gently stirred and reacted for 6 hours.

2. The mixture was cooled to 50° C., and then EDA solution was added dropwisely with syringe to the mixture and chain extension was conducted for 2 hours.

3. TEA was added to neutralize the polymer for another 30 minutes to complete the synthesis of pure hard segment polymer.

C. Film Formation

1. Proper amount of the pure hard segment polymer solution was decanted into a Teflon mould, and dried at 40° C. in a circulate oven for 3 days.

2. Furthermore, the film was dried at 70° C., 10⁻³ torr in a vacuum oven for 3 days. A transparent brittle sample was obtained.

The multiblock waterborne polyurethanes obtained from Example 1˜8 are existing in NMP solvent during the last film formation step when all the water has been driven away from the aqueous PU dispersion. Accordingly, although the properties of such samples in the present invention were discovered in the experiment of waterborne polyurethane, such samples can be prepared through solvent-based methods with ionic or neutral bulky pendant group on the extended chain segment.

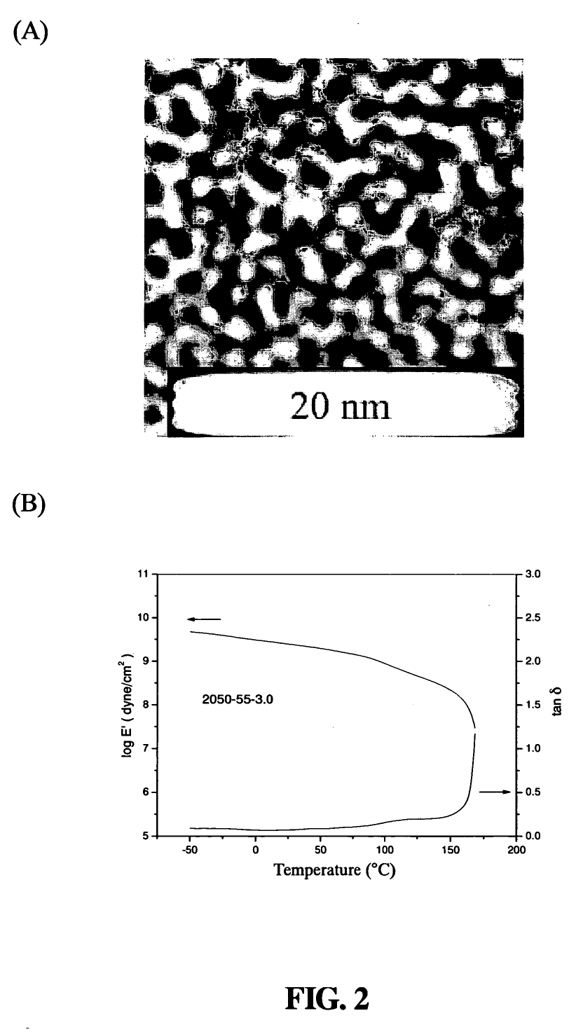

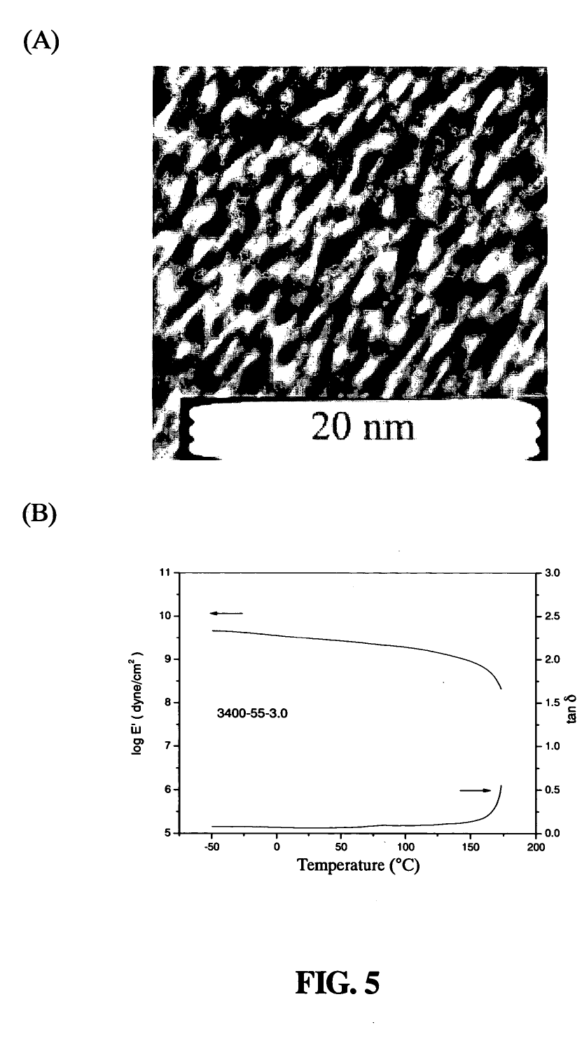

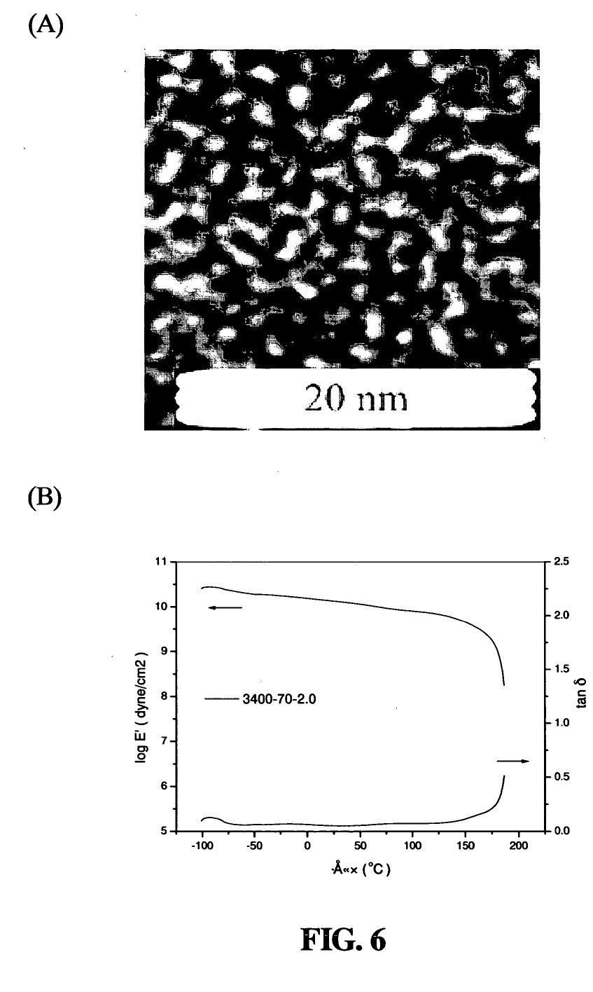

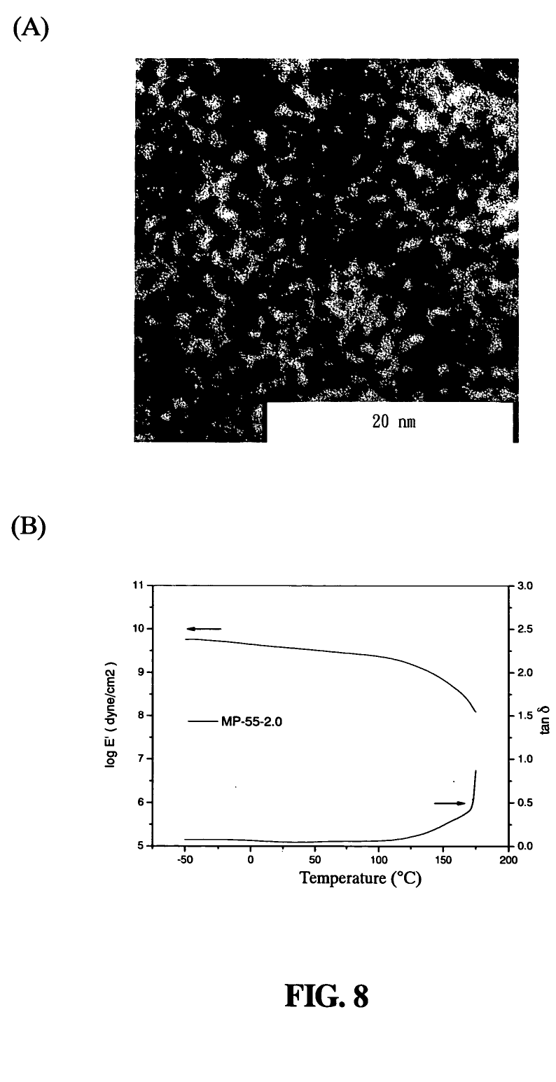

The samples prepared according to the Example 1˜8 are all transparent novel materials with high tensile modulus, high toughness, and good solvent cast processibility. The thickness of all samples is around 0.3 mm. On the other hand, the samples prepared from Example 9 and 10 are polymers with chemical structure and molecular weight very close to those of polyurethane hard segments in Examples 2 and 5, respectively. The samples prepared from Examples 9 and 10 are also transparent, and only one glass transmission temperature (Tg, as shown in Table 3.) was observed at around 60° C. during the DSC (differential scanning calorimeter) scanning up to 250° C. When the environmental temperature is 20˜30° C. higher than the glass transition temperature of these samples, these samples show flow behavior when using forceps to touch it. However, when the temperature is switched back to room temperature (−25° C.), the samples are fragile when forceps touch it. Therefore, they are transparent glassy materials constituted of non-crystalline amorphous polymer at room temperature. When determined by a dynamic mechanical analyzer (part (B) in FIG. 2 to FIG. 9), the flow behavior of the waterborne segmented polyurethane samples (Examples 1˜8) appears at a temperature of ˜180° C., which is more than 100° C. higher than the only Tg of their corresponding pure hard segment polymers obtained from Examples 9 and 10.

The part (A) in FIG. 2 to FIG. 9 is the image of transmission electron microscopy of Examples 1˜8. All polymer chain segments in the white continuous network phase are aligned in an ordered array along the direction of its continuity. This conclusion was summarized from successive comparison of the images of transmission electron microscopy where chemical structures of the polymer blocks were changed systematically. Furthermore, it can be observed that even the length of a H₁₂MDI monomer is longer than the width of the white continuous network phase in abovementioned Examples. Only polymer chains aligned in extended ordered array could this morphology being possible. A white bulky node can be observed in most branching site of the white continuous network phase in the TEM images of all the abovementioned samples. And the size of such node is similar to the size of the neutralization agent, TEA. This similarity proved the location of this bulky TEA moiety. Therefore, the bulky pendant TEA moiety was found to have a function of separating the extended chain segment bundles into branches. Repeatedly aligning the extended chain segment into bundles and repeatedly branching of these bundle finally lead to a 3-D continuous network phase. In further close examinations, a few of the branching sites do not show the bulky TEA moiety, our study indicated that without the initial branching facilitated by the bulky pendent group, it would not be possible to form such a uniform bicontinuous network structure.

Generally, ionic groups of a polyelectrolite are highly aggregated into separate domains in a polymer bulk. In our examples, TEA forms cation and tightly bonds to carboxylic anion of the DMPA monomer unit through an ionic bond. This ion-pair, however, is separately located on the branching site of the extended polymer chain segment bundles. Accordingly, nanostructure prepared based on the present invention has ionic groups very well separated within the bulk of the bicontinuous network material made of the present invention.

The weight percentage of extended polymer chain segment of sample 3400-45-2.0 in Example 3 is as low as 45%, giving rise to an incomplete network structure of extended polymer chain segments bundle as is shown in the TEM image (FIG. 4). However, it is still a network structure being capable of representing infinite continuity basically, but it is also a material with a lower tensile property.

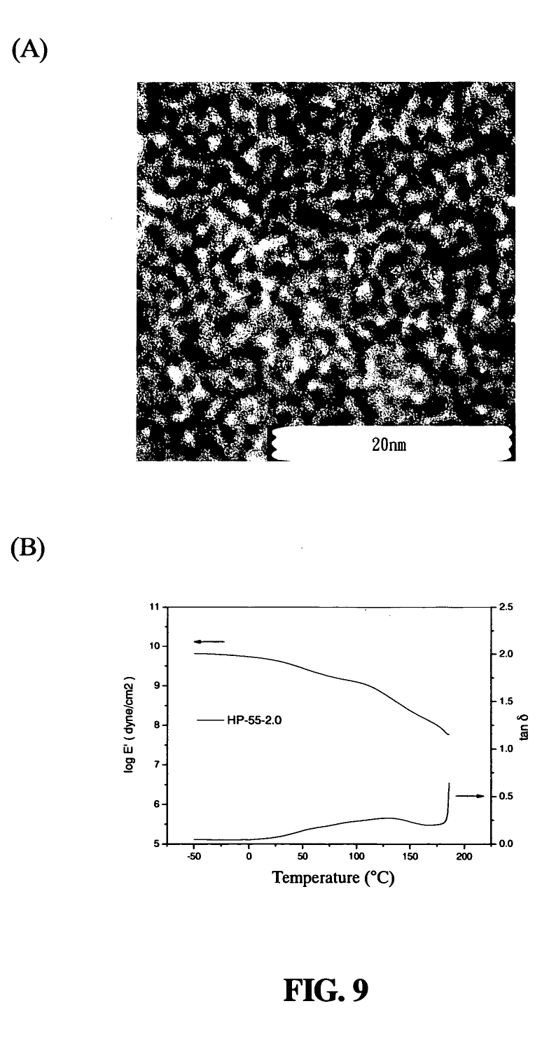

Part B of FIG. 2˜FIG. 9 are the DMA curves of Examples 1˜8. Upper curve is the storage modules (E′) curve of the samples, the measured datum corresponds to the high on left vertical axis (unit: dyne/cm²); lower curve is the corresponding loss tangent (tanδ, unit: no) curve, the measured datum corresponds to the high on right vertical axis. High values of left vertical axis represent high modulus and good dimensional stability. On the other horizontal temperature scale, a better high-temperature property is shown by keeping a steady E′ or tanδ value toward the right end of the temperature scale. When the lower curve (tanδ) rises up sharply, or the upper curve (E′) falls down sharply, these behaviors represent melting of sample material and no high-temperature property again. From these DMA curves, all the segmented waterborne polyurethanes show their high-temperature property up to ˜180° C., indicating the continuous network made with extended aligned chain segment bundle shows more than 100° C. higher in the high-temperature property than that of the pure hard segment polyurethanes with the same chemical structure and molecular weight (polymers in Examples 9 and 10). The later show glass transition temperature at ˜60° C. from DSC measurements.

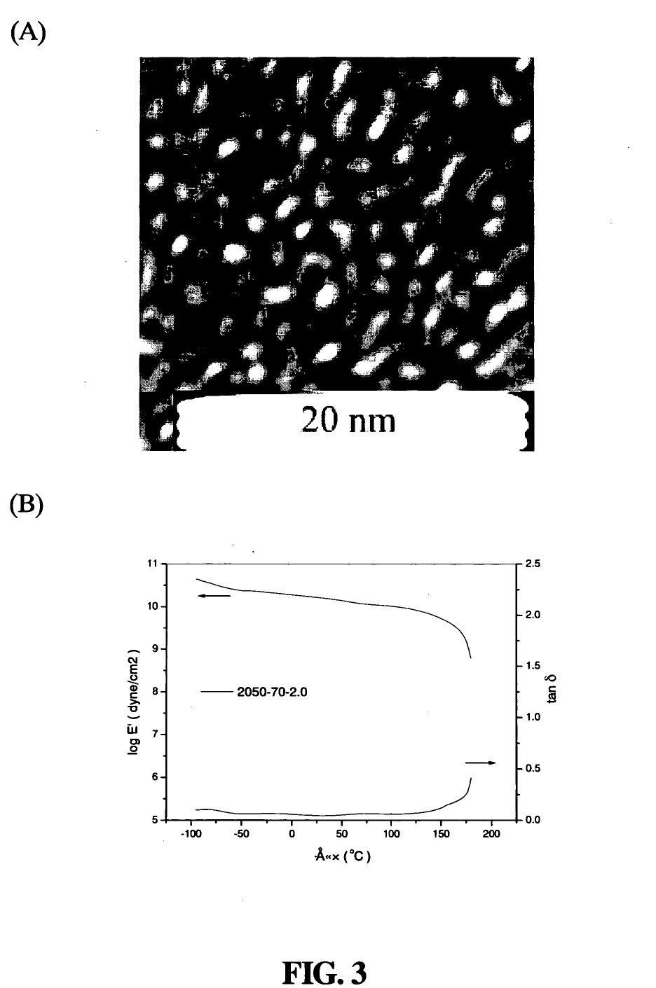

Conventionally, polymeric materials with better high-temperature property would also show high rigidity and brittleness. It will be of the value in special applications if the high-temperature material would also possess some flexible property. In the present invention, samples with higher weight percentage of extended chain segment, such as samples of Example 2 (2050-70-2.0) and Example 5 (3400-70-2.0), give rise to a high room temperature E′ value (E′ about 0.7 to 2×10¹⁰ dynes/cm²), which is similar to most E′ value of general polymeric glassy materials. On the other hand, these samples also show a foldable flexibility when they are bended. To our best understanding, no current polymer with a thickness of 0.3 mm can possess a tough glassy property and together with the properties of high transparency and solvent cast processibility. Furthermore, the DMA curves of Examples 2, 5 and 6 were measured from −110° C., which is the temperature that both of the polymer block are at their glassy state. From DMA curves of the corresponding FIG. 3, 6 and 7, it can be observed that their E′ values at this low temperature are much higher (2˜3 folds greater) than that of general polymeric glassy materials.

The wholly extended H₁₂MDI/EDA(TEA)/DMPA polymer chain segments of abovementioned samples is 20 to 50 nm in length theoretically. The superior mechanical properties and high-temperature properties are a reflection of the greater cohesive strength arising from more extensive intermolecular secondary forces among the closely packed extended chain segments. Accordingly, although the H₁₂MDI/EDA(TEA)/DMPA of the present invention is not a crystalline polymer chain segment, when it exhibits an extended form and aligns in a continuous network according to the present invention, a much better high-temperature property than that of the bulk of the H₁₂MDI/EDA(TEA)/DMPA polymer is reasonable.

Because a crystalline polymer chain segment will fold back and forth on themselves during crystallization and finally forms a lamellae of 5˜10 nm thick, though the crystalline folded-chain segments will form stronger Van der Waals force per unit chain segment between well-packed crystalline chains, the total attraction force of adjacent folded chains is limited by the lamellar thickness. On the other hand, if the highly stereoregular crystalline polymer chain is used to constitute the extended chain segment in the nanostructure of the present invention, it is able to predict that more extensive intermolecular secondary forces among the closely packed extended polymer chain segments may exceed the intermolecular force between the folded chain segments of a crystalline lamelea. Therefore, while a stereoregular polymer constitutes the extended chain bundle of the present invention, network structure of this extended polymer chain bundle may provide a better high-temperature property than Tm of their corresponding crystalline polymer domain.

Based on the abovementioned proof from Examples and the theoretic analysis, the DMA curves will help to tell the existence of the novel bicontinuous nanostructure of the present invention. Indexes, such as the high-temperature property, and/or low temperature E′ value thereof, and/or the toughness over a wide temperature range, are important features for the existence of the novel bicontinuous network structure whenever there are difficulties in analysis of the bicontinuous network structure. Extended polymer chain segment aligns in the continuous network bundle of the present invention will provide much better high-temperature property, higher toughness, and extremely higher modulus than the polymer exists in its individual phase.

For the aspect of mechanical properties, sample 3400-70-2.0 was taken as an example. This sample exhibits an ultimate tensile stress of 41.9 MPa, a Young's modulus of 625.2 MPa, a yield strain at 8%, and an elongation at break of 40%. These mechanical properties again proved this sample to be an extremely tough material.

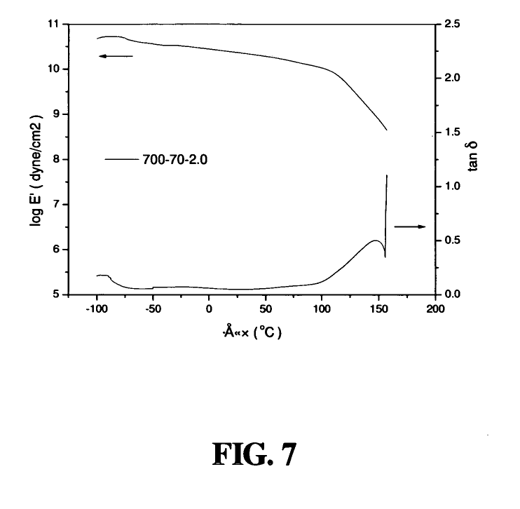

FIG. 7 is the DMA curves of sample 700-70-2.0 as shown in Example 6. The curves also show a high tensile modulus and a very good high-temperature property, these are very similar to DMA curves of Example 1 to Example 5. The ultimate tensile stress for this sample is 46.9 MPa, the Young's module is 724.9 MPa, the yield strain is 11%, and the elongation at break is 114.5%. These mechanical properties are also similar to those of Example 3400-70-2.0. From the mechanical properties, dynamic mechanical properties, and the aforementioned theoretical analysis, it can be assured that sample 700-70-2.0 would exhibit a bicontinuous nanostructure of the present invention. Although DSC studies indicate that the HTPB chain segment of the 700-70-2.0 sample is completely phase-separated by showing a low temperature Tg the same as that of the HTPB polyols, however, because the segment molecular weight of HTPB is only 700, the domain formed from it is too small to be examined by TEM at high magnification. One major reason for this difficulty is that higher power of electron beam must apply in a TEM examination to obtain higher magnification, but the sample tends to be hot-melt or degraded easily when absorbing high electron beam radiation under the electron microscopic observation. That is why there is no transmission electron microscopic image for this sample.

Comparing to Examples 1˜5, Examples 7 is the sample with a different size of neutralization agent (shifted from original TEA to TPA, a larger molecular size) and Examples 8 is a sample with a different type of diisocyanate (shifted from H₁₂MDI to HDI), respectively. From the corresponding images of transmission electron microscope, the bicontinuous network phase structures are the same as those of Examples 1 to 5. Their DMA curves also show similar low temperature E′ values and excellent high-temperature property. Again, it proves that the bicontinuous nanostructure and properties of the multiblock copolymer of the present invention can be reproduced even the component of the extended chain segment and bulky pendant group of the extended polymer chain segment are changed.

In addition, the shape of the monomer unit containing bulky pendant group in the abovementioned samples is basically a tortuous 3-D structure with larger angle. Accordingly, it is reasonable to conclude that monomer having large bended chemical structure is also a factor for facilitating branching of extended polymer chain segment bundle in this present invention.

What is claimed is:

1. A phase separated nano-scale bicontinuous interpenetrating network structure of block copolymer containing two types of self-assembly polymer block, wherein one of the continuous phase is constituted by a polymer block of amorphous chain segment, the other continuous phase is constituted by the other polymer block of extended chain segment in ordered array, the structure of the block copolymer is represented by the following formula:
(˜˜˜˜˜˜˜˜˜˜˜˜˜˜˜++++B+++++B++++++B++)n
wherein “++++B+++++B++++++B++” represents the polymer block with the extended chain segment, which at least comprises a monomer unit represented as “B” which contains a bulky pendant group and/or which is inherently a large tortuous 3-D structure, wherein the monomer unit “B” facilitates branching of the ordered extended chain segment;
“˜˜˜˜˜˜˜˜˜˜˜˜” represents the amorphous chain segment, which is not compatible with “++++B+++++B++++++B++” under the preparation temperature and conditions; and
n is the number of repeating times equal to 0.5 or its integer multipliers, in a range of 1-50.

2. The structure of claim 1, wherein said block copolymer is a diblock copolymer, triblock copolymer, multiblock copolymer or a comb-shape block copolymer.

3. The structure of claim 1, wherein said block copolymer is polymerized by step and/or chain polymerization.

4. The structure of claim 1, wherein the widths of said two continuous phases is 0.3 to 5 nm, respectively.

5. The structure of claim 1, wherein the weight percentage of said polymer block with extended chain segment is 30% to 85%.

6. The structure of claim 1, wherein the molecular weight of said polymer block is 200 to 20,000, respectively.

7. The structure of claim 1, wherein said extended chain segment comprises a monomer unit being capable of participating an inter-chain cross polymerization.

8. The structure of claim 1, wherein said bulky pendant groups is a long chain polymer segment and/or a chemical moiety of substance with low solubility.

9. The structure of claim 1, wherein said amorphous chain segment comprises at least one chemical moiety of substance with low solubility through copolymerization or polymer reaction.

10. The structure of claim 8, wherein said chemical moiety of substance with low solubility is a dopant group of conducting polymer or high polar light emitting group.

11. The structure of claim 9, wherein said chemical moiety of substance with low solubility is a dopant group of conducting polymer or high polar light emitting group.

12. The structure of claim 1, wherein said extended chain segment is formed by a polymer comprising conjugate double bonds.

13. The structure of claim 1, wherein said amorphous polymer block is an ion conductor.

14. The structure of claim 1, wherein said amorphous chain segment is a degradable polymer, removing the amorphous chain segment by decomposition forms a nano porous material with continuous nano pores.

15. A phase separated nano-scale bicontinuous interpenetrating network structure of comb-shape block copolymer containing two types of polymer chain segment, wherein one of the continuous network phase is formed by an amorphous polymer chain segment, the other continuous network phase is formed by aligning the other extended chain segment of the same block copolymer in an ordered array, wherein the extended chain segment constitutes main chain of the comb-shape block copolymer and comprises at least a monomer unit attached with the amorphous chain segment, which is incompatible with the extended main chain segment under the preparation temperature and conditions.
